(19) United States
(12) Patent Application Publication
(10) Pub. No.: US 2010/0237309 A1
(43) Pub. Date: Sep. 23, 2010

(54) Baluster Connection System

(76) Inventors: Ken Ferris, Blue Grass, IA (US); Bryan Purdy, Eldridge, IA (US)

Correspondence Address: HAMILTON IP LAW, PC, 331 W. 3RD ST., NEWVENTURES CENTER SUITE 120, DAVENPORT, IA, 52801, US

(21) Appl. No.: 12/728,245

(22) Filed: Mar. 21, 2010

Related U.S. Application Data
(60) Provisional application No. 61/210,567, filed on Mar. 20, 2009.

(51) Int. Cl. E04H 17/14; B23P 11/00

(52) U.S. Cl. 256/65.01; 29/525.08

(57) ABSTRACT

The various embodiments disclosed and pictured illustrate a baluster connection system for securing a baluster to a rail. The rail includes a channel formed therein, wherein the channel is defined by two opposing channel walls, a channel floor, and the interior surface of the rail top. Two opposing insert tabs may be affixed to each channel wall a predetermined distance from the rail top so that an insert may be placed between the insert tabs and the rail top. The insert includes apertures and baluster catches through which the second end of each baluster connector may pass in a first position of the insert. In a second position of the insert the baluster connector second end is secured within the channel.

### CROSS REFERENCE TO RELATED APPLICATIONS

The present application claims priority from provisional U.S. Pat. App. No. 61/210,567 filed on Mar. 20, 2009, which is incorporated by reference herein in its entirety.

### FIELD OF INVENTION

This invention relates generally to a structure and method for fixing balusters within and between deck or stair rails and the like and more particularly, to a structure and method that hides the ends of the affixed balusters within the hand and/or foot rails of a staircase or the upper and lower rails of a deck assembly.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### BACKGROUND

In both contemporary and traditional architecture, it is quite fashionable and often functional to install a decorative stair rail assembly. Such assemblies typically include upper and lower rail portions that traverse the length of the assembly between two end posts, and a plurality of balusters generally vertically oriented and positioned between the rails. The balusters typically extend vertically between the upper and lower rail portions at longitudinally spaced intervals along the length of the rails. Engaging the balusters with and securing them to the upper and lower rails often proves difficult in various situations.

One solution to this problem often used with wooden components is to drill corresponding holes in each rail and then glue the baluster to each rail, respectively. However, using this method, the glue typically must be applied as the rail assembly is being installed. Furthermore, this type of construction is time consuming and tedious, as both baluster ends must have the appropriate amount of glue. This solution only works with material that is capable of chemical bonding through glue, so it has little value if the structures are metallic or made of a metallic alloy.

Another solution is to weld the balusters into the corresponding rails. This solution is most appropriate for metallic or metal alloy materials. However, this solution also has disadvantages. For example, the engagement point of the baluster and rail may be difficult to reach, making welding a time-consuming and tedious task.

Several attempts at solving the problems mentioned above are found in the prior art. For example, U.S. Pat. No. 4,125,249, which is incorporated by reference herein in its entirety, discloses a railing joint between a baluster and a rail that includes two cooperating members that fit within the interior of the baluster and pivotally engage a first member affixed to a rail. However, the structure taught by this patent includes several components that would be expensive to manufacture, and once a baluster is engaged with the rail, it may not be disengaged easily therefrom.

Accordingly, it is desirable to provide an improved method for connecting a baluster to an upper and/or lower rail that overcomes these problems.

### BRIEF DESCRIPTION OF THE FIGURES

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limited of its scope, the invention will be described and explained with additional specificity and detail through the use of the accompanying drawings.

FIG. 1 provides a side perspective view of three baluster connectors engaged with a rail in the first embodiment of the baluster connection system.

FIG. 2A provides an end view of a baluster connector engaged with a rail in the first embodiment of the baluster connection system.

FIG. 2B provides another end view of a rail in the first embodiment of the baluster connection system without a baluster connector engaged therewith.

FIG. 2C provides a detailed perspective view of a first embodiment of a rail wherein no baluster connector is engaged with the rail.

FIG. 3A provides a detailed perspective view of a first embodiment of a baluster configured for use with the baluster connection system.

FIG. 3B provides a detailed perspective view of a second embodiment of a baluster configured for use with the baluster connection system.

FIG. 4 provides a detailed perspective view of a first embodiment of an insert.

FIG. 5 provides a detailed top view of the first embodiment of a rail that may be used with the baluster connection system.

FIG. 6 provides a detailed top view of the first embodiment of the rail and insert of the baluster connection system in the install position.

FIG. 7 provides a detailed top view of the first embodiment of the rail and insert of the baluster connection system in the retain position.

FIG. 8 provides a perspective view of the baluster connection system configured with two rails with the balusters and rails perpendicular to one another.

FIG. 9 provides a perspective view of the baluster connection system configured with two rails with the balusters and rails non-perpendicular to one another.

### DETAILED DESCRIPTION

### Listing of Elements

| ELEMENT DESCRIPTION | ELEMENT # |
|---|---|
| Baluster connection system | 10 |
| Baluster | 20 |
| Baluster connector | 22 |
| Baluster connector first end | 22a |
| Baluster connector second end | 22b |
| Baluster connector reduced portion | 24 |
| Rail | 30 |
| Rail top | 31a |
| Rail side | 31b |
| Rail bottom | 31c |
| Insert tab | 32 |
| Channel | 34 |
| Channel floor | 35 |
| Channel wall | 36 |
| Baluster connector slot | 37 |
| Rail Support | 38 |
| Insert | 40 |
| Baluster connector catch | 42 |
| Aperture | 44 |

### DETAILED DESCRIPTION

Before the various embodiments of the present disclosure are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that phraseology and terminology used herein with reference to device or element orientation (such as, for example, terms like “front”, “back”, “up”, “down”, “top”, “bottom”, and the like) are only used to simplify description of the present invention, and do not alone indicate or imply that the device or element referred to must have a particular orientation. In addition, terms such as “first”, “second”, and “third” are used herein and in the appended claims for purposes of description and are not intended to indicate or imply relative importance or significance.

### 1. Structural Description of the Baluster Connection System

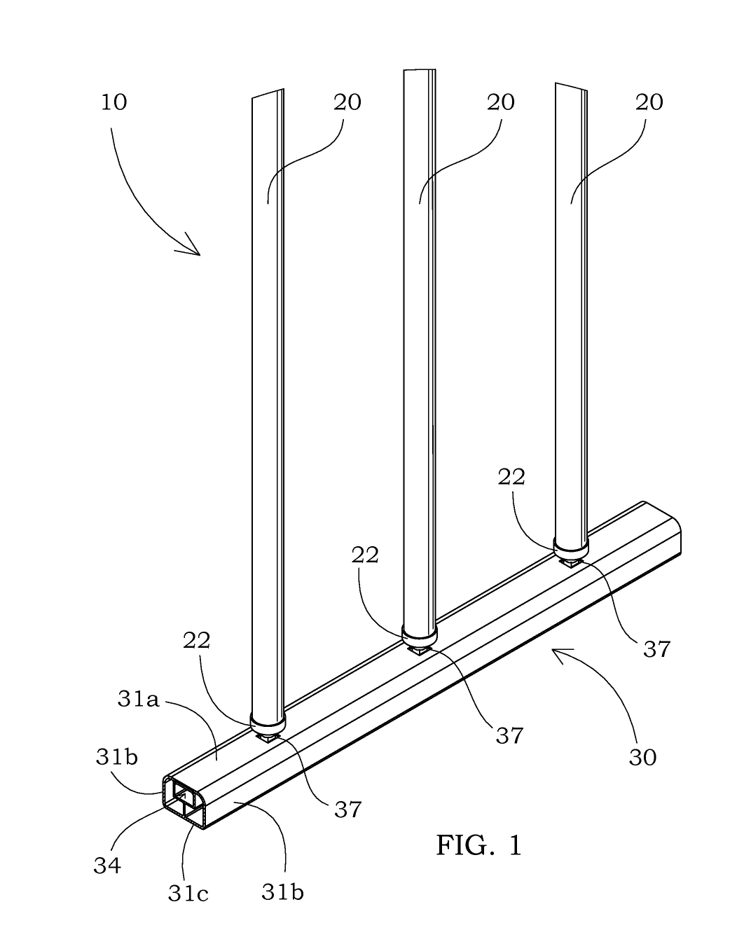

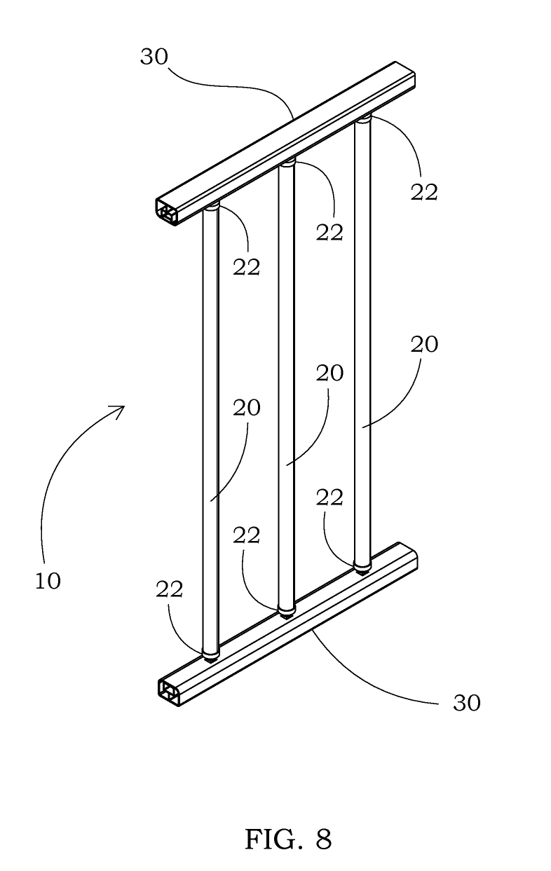

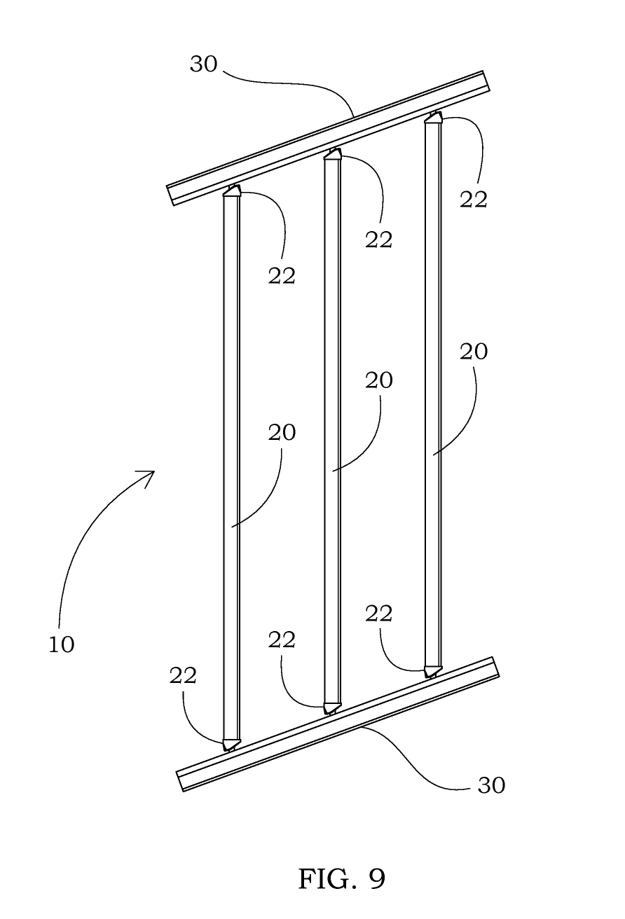

Referring now to the drawings, wherein like reference numerals designate identical or corresponding parts throughout the several views, FIG. 1 provides a perspective view of a first embodiment of the baluster connection system 10. The baluster connection system 10 as shown includes a plurality of balusters 20 engaged with at least one rail 30. As shown in FIG. 1, the rail 30 is configured as a bottom rail 30 as opposed to a hand rail 30. However, the baluster connection system 10 may be used with either type of rail 30, or it may be used with both types simultaneously. The baluster connection system 10 is shown in FIGS. 8 and 9 simultaneously employed with both a hand rail 30 and foot rail 30. As is apparent from FIGS. 8 and 9, the baluster connection system 10 allows for nearly infinite adjustment of the relative angle between each rail 30 and each baluster 20. Accordingly, the specific angle between any rail 30 and baluster 20 in no way limits the scope of the baluster connection system 10 as disclosed and claimed herein.

In the embodiment pictured in FIGS. 1, 8, and 9, three balusters 20 are shown connected to at least one rail 30 using the baluster connection system 10. However, in other embodiments not pictured herein, different numbers of balusters 20 and rails 30 may be used, and the number of balusters 20 and/or rails 30 in no way limits the scope of the baluster connection system 10. Furthermore, any length of baluster 20 may be used with the baluster connection system 10 without limitation.

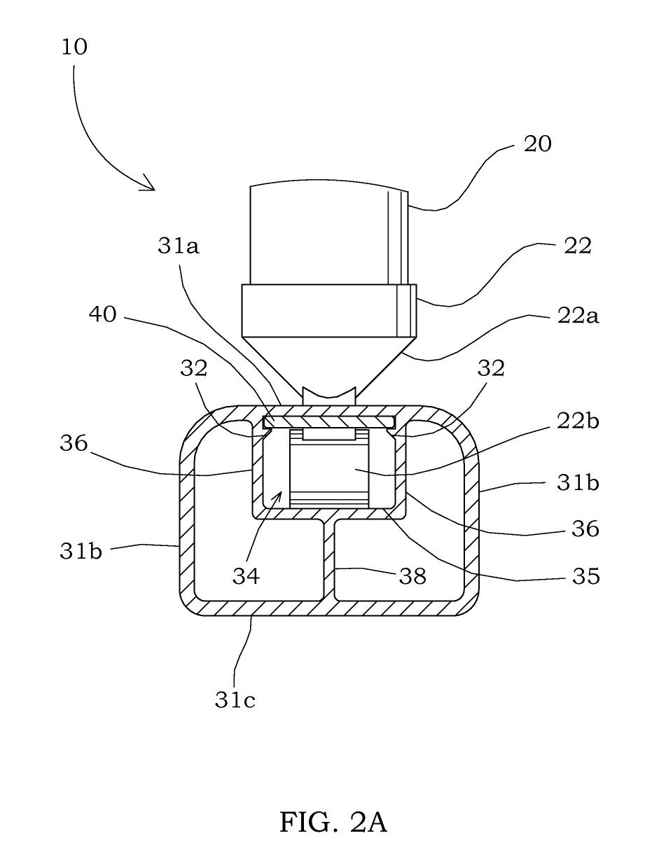

The end of the baluster connection system 10 is shown in detail in FIG. 2A, wherein a baluster connector 22 is positioned within the rail 30. A cross-sectional view of a rail 30 that may be used with the first embodiment of the baluster connection system 10 is shown in FIG. 2B, wherein no baluster connector 22 is positioned within the rail 30. As shown in FIGS. 2A and 2B, the rail 30 may be formed with a rail top 31a, two opposing rail sides 31b, and a rail bottom 31c. Corresponding ends of the rail sides 31b are affixed to the rail top 31a and the opposite ends of the rail sides 31b are affixed to the rail bottom 31c. At least one baluster slot 37 may be formed in the rail top 31a. The baluster slot(s) 37 pass from the exterior of the rail top 31a into the channel 34. Any number of baluster slots 37 may be formed in the rail 30 without limitation as long as there is one baluster slot 37 for each baluster 20 that is to be connected to the rail 30 using the baluster connection system 10.

A channel 34 is formed in the interior of the rail 30, which is best shown in FIGS. 2A-2C. The channel 34 may be formed by two opposing channel walls 36 and a channel floor 35. The bottom end of each channel wall 36 is affixed to the channel floor 35. The top end of each channel wall 36 is affixed to the interior surface of the rail top 31a. The first embodiment of a rail 30 includes a rail support 38, one end of which is affixed to the outer surface (i.e., the surface facing away from the channel 34) of the channel floor 35 and the other end of which is affixed to the interior surface of the rail bottom 31c.

An insert tab 32 may be formed on each channel wall 36. In the embodiment pictured herein, the insert tabs 32 are closer to the rail top 31a than they are to the rail bottom 31c. However, in other embodiments not pictured herein, the insert tabs 32 are positioned elsewhere. Accordingly, the various configurations, orientations, and geometries that may be employed in the baluster connection system 10 for the rail 30, channel 34, and insert tabs 32 in no way limit the scope of the baluster connection system 10.

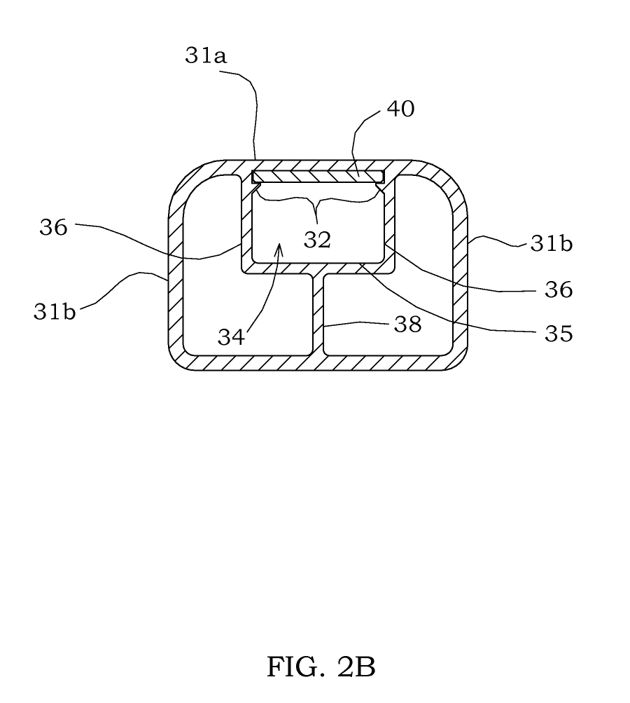

A perspective view of a first embodiment of a baluster connector 20 for use in the first embodiment of the baluster connection system 10 is shown in perspective in FIG. 3A. The baluster connector 20 may be formed with a baluster connector first end 22a and a baluster connector second end 22b. The baluster connector first and second ends 22a, 22b are connected to one another via a baluster connector reduced portion 24. The baluster connector first end 22a is shown protruding from the rail 30 in FIGS. 1 and 2A adjacent the rail top 31a. The first embodiment of a baluster connector 20 possesses two vertical planes of symmetry about the longitudinal axis of the baluster connector reduced portion 24. In the first embodiment, the baluster connector first end 22a is generally conically shaped, the baluster connector reduced portion 24 has a square cross-sectional shape, and the baluster connector second end 22b is generally cylindrically shaped. However, in other embodiments those elements may be configured differently, as explained in detail below.

The baluster connector first end 22a may be configured to secure one end of a baluster 20 thereto, as shown in FIGS. 1 and 2A. In the embodiment shown in those figures, the baluster 20 is secured to the baluster connector first end 22a through an interference-type fit. However, in other embodiments not pictured herein, the baluster 20 may be secured to the baluster connector first end 22a through other methods and/or structures. For example, the baluster 20 may be secured to the baluster connector first end 22a using screws (not shown), chemical compounds, or any other structure and/or method known to those skilled in the art. Accordingly, the method and/or structure used to secure the baluster 20 to the baluster connector first end 22a in no way limits the scope of the baluster connection system 10 as disclosed and claimed herein.

As shown in FIG. 2A, at least a portion of the baluster reduced portion 24 passes from the exterior of the rail top 31a into the channel 34 via the baluster connector slot 37 formed in the rail 30. When the baluster connector 22 is engaged with the rail 30 (as best shown in FIGS. 1 and 2A) in the first embodiment of the baluster connection system 10, the baluster connector second end 22b is not visible from the exterior of the baluster connection system 10, and the baluster connector second end 22b is positioned in the channel 34. In the first embodiment, the baluster connector first end 22a, baluster connector second end 22b, and baluster connector reduced portion 24 all have different cross-sectional shapes and areas from one another, as previously described. However, in other embodiments only the cross-sectional shapes are different, and in still other embodiments only the cross sectional areas are different.

The baluster connector first end 22a may have any length desired for the specific application of the baluster connection system 10, and the length of the baluster connector first end 22a in no way limits the scope of the baluster connection system 10. Similarly, the length of the baluster connector reduced portion 24 and/or the baluster connector second end 22b in no way limits the scope of the baluster connection system 10 and the optimal dimensions therefor will vary from one application to the next. Accordingly, in an embodiment not pictured herein, when assembled the baluster connection system 10 may be configured so that no amount of the baluster connector reduced portion 24 is visible from the exterior of the rail 30. In other embodiments not pictured herein, the length of the baluster connector reduced portion 24 protruding from the exterior of the rail 30 will be greater than shown in any embodiments pictured herein.

A second embodiment of a baluster connector 22 is shown in FIG. 3B. In the second embodiment, the shape and configuration of the baluster connector first end 22a is different from that of the first embodiment. As shown, the baluster connector first end 22a of the second embodiment includes an angled portion on the surface adjacent the baluster connector reduced portion 24. The second embodiment is ideal for applications of the baluster connector system 10 wherein the rail(s) 30 are not perpendicular to the balusters 20, such as the orientation shown in FIG. 9. The angled portion of the baluster connector first end 22a allows the baluster connector first end 22a to more closely follow the angle of the rail 30, and therefore reduce the visible gap between the baluster connector first end 22a and the rail top 31a. The optimal angle on the baluster first end 22a in the second embodiment will vary from one application to the next, but it is contemplated that the most aesthetically pleasing configuration will occur when the angle closely approximates that of the of rail 30 to which the baluster connector 22 is engaged.

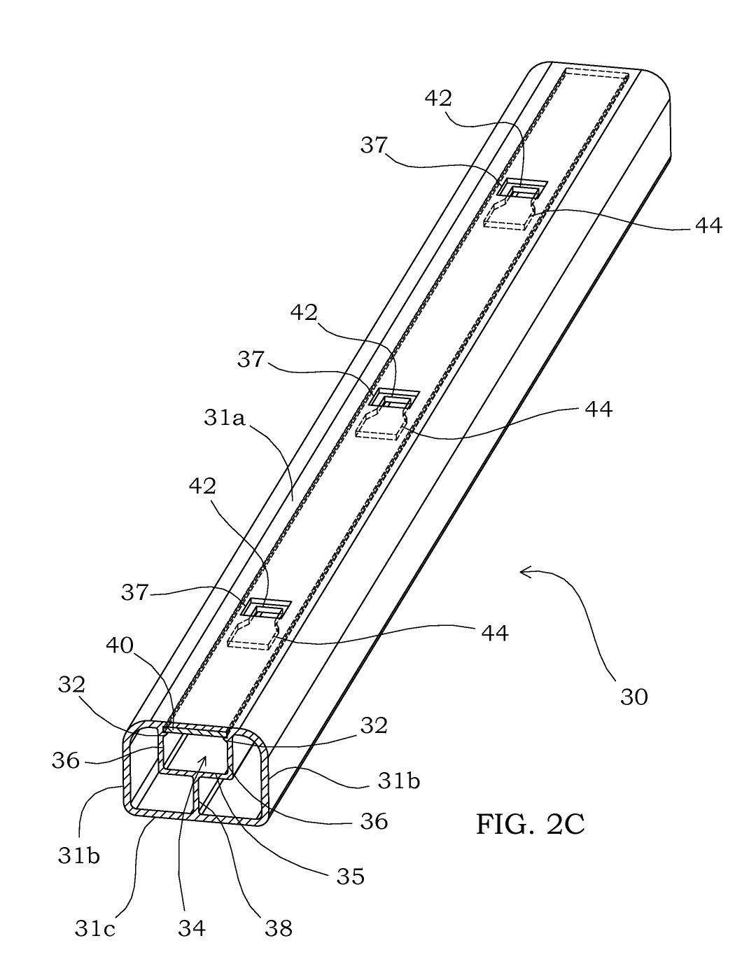

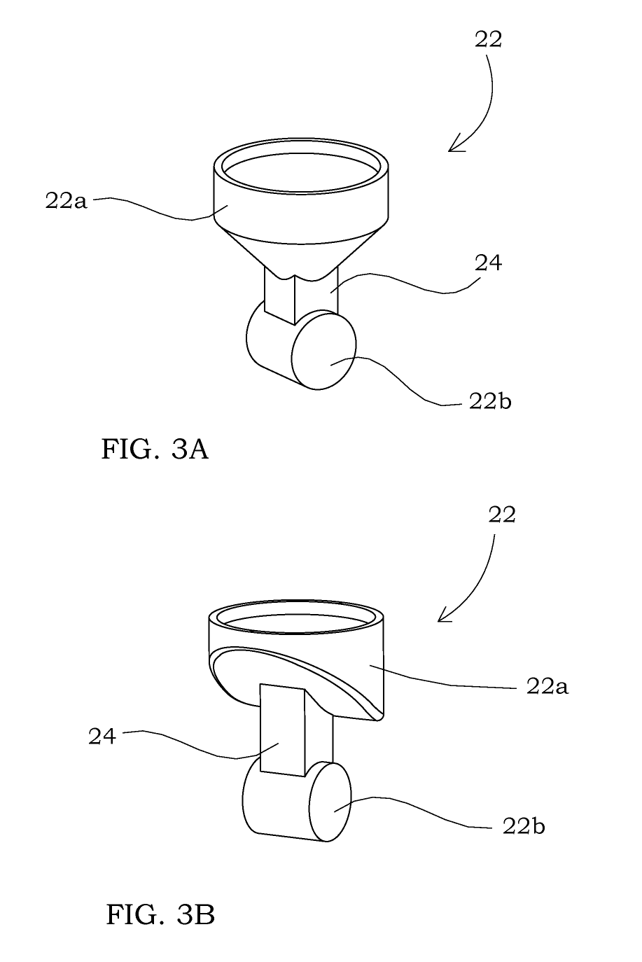

A perspective view of a first embodiment of an insert 40 is shown in FIG. 4. In the first embodiment, the insert 40 is formed with three apertures 44 and three baluster connector catches 42 adjacent thereto. As shown in FIG. 2A, the insert 40 and insert tabs 32 are configured such that the insert 40 may be positioned between the insert tabs 32 and the interior surface of the rail top 31a. Accordingly, the insert 40 may be slidably engaged with the rail 30 by placing the insert 40 in the space between the insert tabs 32 and the interior surface of the rail top 31a. In the first embodiment, the insert 40 includes one aperture 44 and one baluster connector catch 42 for each baluster 20 in the baluster connection system 10.

### 2. Description of One Method of Using the Baluster Connection System

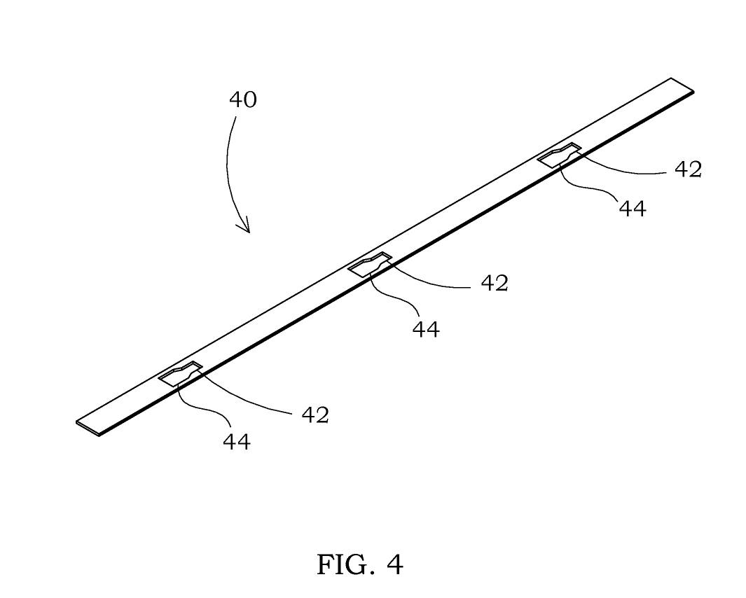

To assemble the baluster connection system 10, the insert 40 is engaged with the rail 30 in the space between the insert tabs 32 and interior surface of the rail top 31a. The insert 40 is then moved to the position as shown in FIG. 6, wherein the apertures 44 of the insert 40 are aligned with the baluster connector slots 37 in the rail top 31a. At this point, the baluster connector second end 22b may pass through both the baluster slot 37 and the aperture 44 so that the baluster connector second end 22b is positioned within the channel 34.

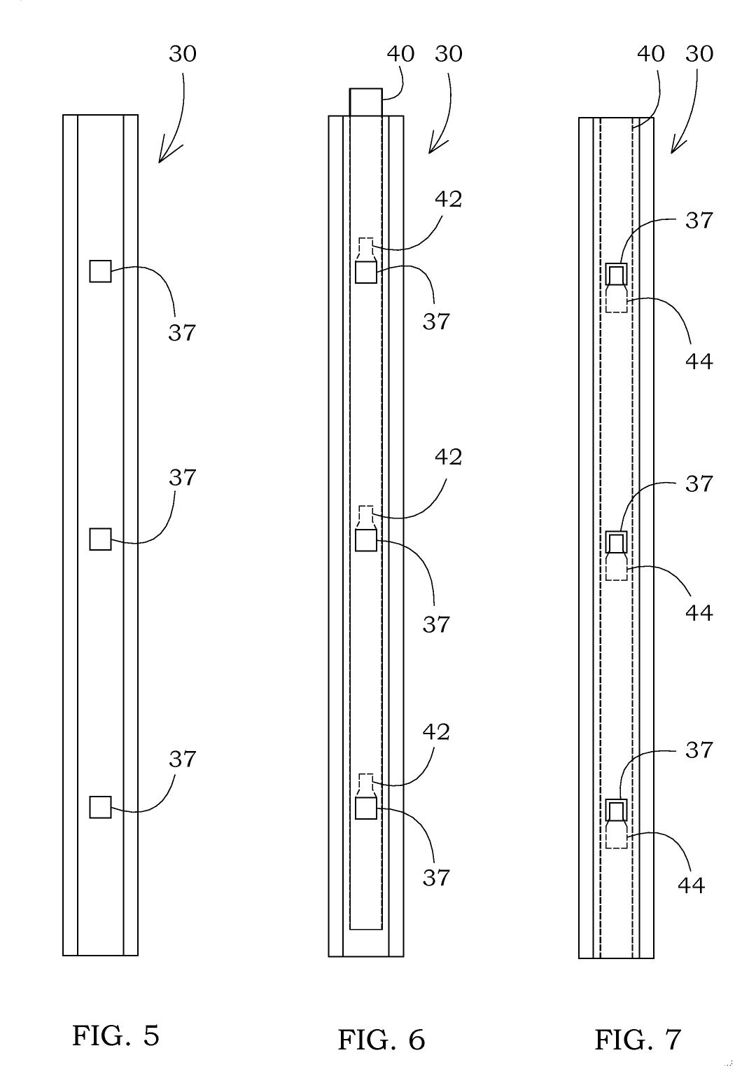

Once the baluster connector second end 22b has been positioned in the channel 34, the insert 40 may be positioned as shown in FIG. 7 (in which the baluster connectors 22 are not shown for purposes of clarity) so that the baluster connector reduced portion 24 is engaged with the baluster connector catch 42 in the insert 40. Because the cross-sectional area of the baluster connector reduced portion 24 is less than that of the baluster connector second end 22b, when the insert 40 is positioned as shown in FIG. 7, the baluster connector second end 22b is secured within the channel 34 by the baluster connector catch 42. The baluster connector catch 42 and baluster connector reduced portion 24 are configured so that the insert 40 may be positioned as shown in FIG. 7 with a baluster connector 22 properly positioned in each baluster slot 37.

In other embodiments of the baluster connection system 10, the insert 40 may have more or fewer apertures 44 and baluster connector catches 42, and the precise orientation, shape and configuration of the apertures 44 and baluster connector catches 42 may vary from one embodiment of the baluster connection system 10 to the next. As long as the baluster connector 22, baluster connector second end 22b, baluster connector reduced portion 24, rail 30, channel 34, baluster connector slot 37, insert 40, baluster connector catch 42, and aperture 44 are configured so that in a first position of the insert 40 the baluster connector second end 22b is retained in the channel 34 by the baluster connector catch 42 and in a second position of the insert 40 the baluster connector second end 22b may be removed from the channel 34, any configuration of the aforementioned elements may be employed without departing from the spirit and scope of the baluster connection system 10.

Although not shown in the various embodiments pictured herein, in other embodiments of the baluster connection system 10 a baluster 20 secured to the baluster connector first end 22a may be engaged (at the end of the baluster 20 opposite the baluster connector first end 22a) with a floor or other structure directly rather than with another rail in a similar manner. In still other embodiments not pictured herein, the baluster connector first end 22a may be engaged with structures other than a baluster 20. Accordingly, the baluster connection system 10 is not limited to whether each baluster connector 22 is connected to a baluster 20, and/or whether each baluster 20 is connected to a rail 30 or other structure at each end of the baluster 20, but applies to embodiments having either one or two rails 30 as shown in FIGS. 1, 8, and 9.

In the various embodiments pictured and described herein it is contemplated that the rail 30, baluster connector 22, the baluster 23, and insert 40 will be constructed of any suitable material known to those skilled in the art, including but not limited to a plastic or polymer material, metal, metallic alloys, cellulosic materials, and/or combinations thereof. The optimal material of construction will vary from one application to the next and be at least partly influenced by the strength required for the application of the baluster connection system 10.

The specific cross-sectional areas and/or shapes of the rail 30, insert tabs 32, channel 34, baluster connector first end 22a, baluster connector second end 22b, baluster connector reduced portion 24, baluster connector catch 42, and/or aperture 44 in no way limit the scope of the baluster connection system 10. As is apparent to those skilled in the art, an infinite number of cross-sectional areas and/or shapes exist for the elements listed above.

It should be noted that the baluster connection system 10 is not limited to the specific embodiments pictured and described herein, but is intended to apply to all similar apparatuses for attaching and supporting balusters 20 and/or baluster connectors 22 to rails 30. Modifications and alterations from the described embodiments will occur to those skilled in the art without departure from the spirit and scope of the baluster connection system 10.

1. A baluster connection system comprising:
a. a baluster connector comprising:
i. a baluster connector first end;
ii. a baluster connector second end, wherein the cross-sectional area of said baluster connector second end is less than that of said baluster first end;
iii. a baluster connector reduced portion, wherein said baluster connector reduced portion is affixed to both said baluster connector first and second ends, and wherein the cross-sectional area of said baluster connector reduced portion is less than that of said baluster connector second end;
b. a rail comprising:
i. a channel, wherein said channel is formed in the interior of said rail and extends along the length thereof;
ii. a channel floor defining the bottom of said channel;
iii. a first channel wall defining a first horizontal limit of said channel;
iv. a second channel wall defining a second horizontal limit of said channel;
v. a first insert tab, wherein said first insert tab is affixed to said first channel wall and extends therefrom into said channel;
vi. a second insert tab, wherein said second insert tab is affixed to said second channel wall and extends therefrom into said channel;
vii. at least one baluster connector slot, wherein said at least one baluster slot is formed in said rail and provides a passage from the exterior of said rail into said channel;
c. an insert comprising:
i. at least one aperture, wherein said at least one aperture is sized and shaped so that said baluster connector second end may pass through said at least one aperture, and wherein said insert is configured to slide along said rail between the interior surface of said rail top and said first and second insert tabs; and
ii. at least one baluster connector catch, wherein said at least one baluster connector catch is positioned adjacent said at least one aperture, and wherein said at least one baluster connector catch is sized and shaped so that said baluster connector second end cannot pass through said at least one baluster connector catch.

2. The baluster connection system according to claim 1 wherein said baluster connector is further defined as having a baluster first end with a circular cross-sectional shape.

3. The baluster connection system according to claim 1 wherein said rail further comprises a rail support extending from the bottom of said rail to said channel floor.

4. The baluster connection system according to claim 1 wherein said rail is further defined as a handrail.

5. The baluster connection system according to claim 1 wherein said rail is further defined as a bottom rail.

6. The baluster connection system according to claim 1 wherein said baluster connector reduced portion is further defined as having a square cross-sectional shape.

7. The baluster connection system according to claim 1 wherein said rail further comprises a plurality of baluster slots.

8. The baluster connection system according to claim 7 wherein said plurality of baluster slots is further defined as being equally spaced from one another, wherein said at least one aperture in said insert is further defined as being equal in number to said plurality of baluster slots and equally spaced from one another by an amount equal to the spacing between each baluster slot in said plurality of baluster slots.

9. A baluster connector comprising:
a. a baluster connector first end;
b. a baluster connector reduced portion affixed to said baluster connector first end; and
c. a baluster connector second end affixed to said baluster connector reduced portion, wherein the periphery of said baluster connector reduced portion is less than that of either said baluster connector first or second ends.

10. The baluster connector according to claim 9 wherein said baluster connector first end is further defined as having a circular cross-sectional shape.

11. The baluster connector according to claim 10 wherein said baluster connector reduced portion is further defined as having a square cross-sectional shape.

12. The baluster connector according to claim 11 wherein said baluster connector first end is configured for an application wherein a baluster engaged with said baluster connector and a rail engaged with said baluster connector are non-parallel.

13. The baluster connector according to claim 11 wherein said baluster connector is configured to have at least one plane of symmetry parallel to the longitudinal axis of said baluster connector reduced portion.

14. A railing comprising:
a. a hand rail comprising;
i. a rail channel, wherein said rail channel is formed in the interior of said hand rail and extends along the length thereof;
ii. a rail channel floor defining the bottom of said rail channel;
iii. a first rail channel wall defining a first horizontal limit of said channel;
iv. a second channel wall defining a second horizontal limit of said channel;
v. a first insert tab, wherein said first insert tab is affixed to said first channel wall and extends therefrom into said channel;
vi. a second insert tab, wherein said second insert tab is affixed to said second channel wall and extends therefrom into said channel;
vii. at least one baluster connector slot, wherein said at least one baluster slot is formed in said rail and provides a passage from the exterior of said rail into said channel;
b. a bottom rail comprising;
i. a rail channel, wherein said rail channel is formed in the interior of said bottom rail and extends along the length thereof;
ii. a rail channel floor defining the bottom of said rail channel;
iii. a first rail channel wall defining a first horizontal limit of said channel;
iv. a second channel wall defining a second horizontal limit of said channel;
v. a first insert tab, wherein said first insert tab is affixed to said first channel wall and extends therefrom into said channel;
vi. a second insert tab, wherein said second insert tab is affixed to said second channel wall and extends therefrom into said channel;
vii. at least one baluster connector slot, wherein said at least one baluster slot is formed in said rail and provides a passage from the exterior of said rail into said channel;
c. a first baluster connector;
i. a baluster connector first end;
ii. a baluster connector second end, wherein the cross-sectional area of said baluster connector second end is less than that of said baluster connector first end;
iii. a baluster connector reduced portion, wherein said baluster connector reduced portion is affixed to both said baluster connector first and second ends, and wherein the cross-sectional area of said baluster connector reduced portion is less than that of said baluster connector second end;
d. a second baluster connector;
i. a baluster connector first end;
ii. a baluster connector second end, wherein the cross-sectional area of said baluster connector second end is less than that of said baluster connector first end;
iii. a baluster connector reduced portion, wherein said baluster connector reduced portion is affixed to both said baluster connector first and second ends, and wherein the cross-sectional area of said baluster connector reduced portion is less than that of said baluster connector second end;
e. a first insert comprising:
i. at least one aperture, wherein said at least one aperture is sized and shaped so that said baluster connector second end of said first baluster connector may pass through said at least one aperture, and wherein said insert is configured to slide along said rail between the interior surface of said rail top and said first and second insert tabs of said hand rail;
ii. at least one baluster connector catch, wherein said at least one baluster connector catch is positioned adjacent said at least one aperture, and wherein said at least one baluster connector catch is sized and shaped so that said baluster connector second end of said first baluster connector cannot pass through said at least one baluster connector catch;
f. a second insert comprising:
i. at least one aperture, wherein said at least one aperture is sized and shaped so that said baluster connector second end of said second baluster connector may pass through said at least one aperture, and wherein said insert is configured to slide along said rail between the interior surface of said rail top and said first and second insert tabs of said bottom rail;
ii. at least one baluster connector catch, wherein said at least one baluster connector catch is positioned adjacent said at least one aperture, and wherein said at least one baluster connector catch is sized and shaped so that said baluster connector second end of said second baluster connector cannot pass through said at least one baluster connector catch; and
g. a baluster, wherein one end of said baluster is engaged with said first baluster connector first end, and wherein the opposite end of said baluster is engaged with said second baluster connector first end.

15. The baluster connection system according to claim 14 wherein said baluster connection system is further defined as comprising a plurality of balusters.

16. A method for securing a baluster to a rail, said method comprising:
a. affixing said rail to a structure, wherein said rail comprises:
i. a rail channel, wherein said rail channel is formed in the interior of said rail and extends along the length thereof;
ii. a rail channel floor defining the bottom of said rail channel;
iii. a first rail channel wall defining a first horizontal limit of said channel;
iv. a second channel wall defining a second horizontal limit of said channel;
v. a first insert tab, wherein said first insert tab is affixed to said first channel wall and extends therefrom into said channel;
vi. a second insert tab, wherein said second insert tab is affixed to said second channel wall and extends therefrom into said channel;
vii. at least one baluster connector slot, wherein said at least one baluster slot is formed in said rail and provides a passage from the exterior of said rail into said channel;
b. positioning an insert between the interior of said rail top and said first and said first and second insert tabs, wherein said insert comprises:
i. at least one aperture, wherein said at least one aperture is sized and shaped so that said baluster connector second end may pass through said at least one aperture; and
ii. at least one baluster connector catch, wherein said at least one baluster connector catch is positioned adjacent said at least one aperture, and wherein said at least one baluster connector catch is sized and shaped so that said baluster connector second end cannot pass through said at least one baluster connector catch;
c. sliding said insert within said rail such that said at least one aperture in said insert aligns with said at least one baluster connector slot in said rail;
d. placing a baluster connector second end through both said at least one baluster connector slot and said at least one aperture, wherein said baluster connector second end is part of a baluster connector, wherein said baluster connector comprises:
i. a baluster connector first end;
ii. a baluster connector reduced portion, wherein said baluster connector reduced portion is affixed to both said baluster connector first and second ends, and wherein the cross-sectional area of said baluster connector reduced portion is less than that of said baluster connector second end;
e. engaging a baluster with said baluster connector first end; and
f. sliding said insert within said rail such that said at least one baluster connector catch is positioned around a portion of the periphery of said baluster connector reduced portion.
